(19) United States
(12) Patent Application Publication
(10) Pub. No.: US 2024/0176833 A1
(43) Pub. Date: May 30, 2024

(54) INTERNET RECOMMENDATION METHOD, SYSTEM AND APPARATUS, AND COMPUTER READABLE STORAGE MEDIUM

(71) Applicant: SHANGHAI FUSION MANAGEMENT SOFTWARE CO., LTD., Shanghai (CN)

(72) Inventor: Kaiyi ZHU, Shanghai (CN)

(73) Assignee: SHANGHAI FUSION MANAGEMENT SOFTWARE CO., LTD., Shanghai (CN)

(21) Appl. No.: 18/552,668

(22) PCT Filed: Apr. 7, 2022
(86) PCT No.: PCT/CN2022/085479

§ 371 Date: Sep. 27, 2023

(30) Foreign Application Priority Data
Apr. 8, 2021 (CN) 202110375733.3

(51) Int. Cl. G06F 16/9535

(52) U.S. Cl. CPC G06F 16/9535

(57) ABSTRACT

An Internet recommendation method, system and apparatus, and a computer readable storage medium, which relate to the technical field of computers. The method comprises: first acquiring current search information inputted by a client, and then determining, in a tree structure information chain, a first node corresponding to the current search information. A server end also stores second nodes corresponding to historical search and storage information inputted by other clients and to the tree structure information chain. A first node is matched with each second node according to a preset matching rule, and the matching result is sent to a client, so that the range of secondary screening can be reduced while the range of primary screening is guaranteed to be large enough, facilitating users to find a target social user.

The present application claims priority to Chinese Patent Application No. 202110375733.3, titled “COMBINATION INNOVATION RECOMMENDATION METHOD AND SYSTEM THEREOF”, filed on Apr. 8, 2021 with the China National Intellectual Property Administration, which is incorporated herein by reference in its entirety.

### FIELD

The present disclosure relates to the technical field of computers, and in particular to an Internet recommendation method, an Internet recommendation system, an Internet recommendation device, and a computer-readable storage medium.

### BACKGROUND

The Internet has brought infinite possibilities for people to socialize from afar. For example, the user may enter search information in a search engine such as Baidu and find a target social user that matches the search information. However, in this way, a very large number of initial screening results are obtained, so that it is required for the user to manually perform secondary screening to select a target social user that meets the user's requirements. In addition, the user may find a target social user by using social software such as Facebook or WeChat. However, in this way, it is required for the user to know account information of the target social user, and the scope of initial screening is relatively limited. Especially in the field of innovation, socializing often requires a combination of multiple cross disciplinary talents. However, the problems, fields, talents, keywords, and combinations thereof in the original innovation and the forefront of innovation are imprecise and indescribable. Typical examples include a combination of an investment finance expert and an innovation technology expert and a combination of interdisciplinary innovative technology experts in edge sciences, which expressing ambiguous social purpose domains. Thus, it is required for a system to provide the user with a transition for matching a vague input to an accurate definition. It is required to achieve both a maximum range of initial matching and a significant reduction in the workload of manual secondary screening.

### SUMMARY

An objective of the present disclosure is to provide an Internet recommendation method, an Internet recommendation system, an Internet recommendation device and a computer-readable storage medium, to ensure a sufficiently large scope of initial screening and reduce the scope of secondary screening in the user socializing through the Internet and facilitate the user finding a target social user.

In order to solve the above technical problems, an Internet recommendation method is provided according to the present disclosure. The Internet recommendation method is applied to a server. The method includes: obtaining current search information inputted by a client; determining, in a tree-structure information chain pre-stored in the server, a first node corresponding to the current search information, where the tree-structure information chain includes multiple nodes in a tree structure and node information corresponding to the nodes one by one; matching, according to a predetermined matching rule, the first node with second nodes corresponding to historical search and storage information of other clients stored in the server to obtain a matching result; and sending the matching result to the client.

Preferably, the matching, according to a predetermined matching rule, the first node with second nodes corresponding to historical search and storage information of other clients stored in the server to obtain a matching result includes: obtaining distances between the first node and the second nodes based on the tree-structure information chain; arranging the distances in a rule from near to far to obtain a first distance sequence; obtaining a second node sequence based on the first distance sequence and a correspondence relationship between the distances in the first distance sequence and the second nodes; and obtaining the matching result based on a correspondence relationship between the second node sequence and the historical search and storage information.

Preferably, in a case of multiple second nodes having a same distance from the first node, after obtaining the second node sequence based on the first distance sequence and the correspondence relationship between the distances in the first distance sequence and the second nodes, the Internet recommendation method further includes: determining a relationship between each of the second nodes having the same distance from the first node and the first node based on the tree-structure information chain, where the relationship between each of the second nodes and the first node includes that the second node is a child node of the first node, the second node is a peer node of the first node, and the second node is a parent node of the first node; and arranging the second nodes having the same distance from the first node in the second node sequence in an order of a second node being a child node of the first node, a second node being a peer node of the first node, and then a second node being a parent node of the first node.

Preferably, in a case that multiple identical distances exist in the first distance sequence, after obtaining the second node sequence based on the first distance sequence and the correspondence relationship between the distances in the first distance sequence and the second nodes, the Internet recommendation method further includes: arranging, based on storage time instants of the second nodes, second nodes having a same distance from the first node in the second node sequence in an order of the storage time instants from late to early.

Preferably, the obtaining current search information inputted by a client includes: obtaining the current search information selected by the client from a predetermined menu bar, where a structure of the predetermined menu bar is identical to a structure of the tree-structure information chain or is identical to a structure of a level of the tree-structure information chain.

Preferably, the obtaining current search information inputted by a client further includes: obtaining current custom search information inputted by the client. The determining, in a tree-structure information chain pre-stored in the server, a first node corresponding to the current search information includes: determining, in the tree-structure information chain, the first node corresponding to the current search information selected by the client from the predetermined menu bar and/or the current custom search information.

In order to solve the above technical solutions, an Internet recommendation system is further provided according to the present disclosure. The system includes a search information obtaining unit, a first node determination unit, a matching unit, and a sending unit. The search information obtaining unit is configured to obtain search information inputted by a client. The first node determination unit is configured to determine, in a tree-structure information chain pre-stored in a server, a first node corresponding to the search information. The matching unit is configured to match, according to a predetermined matching rule, the first node with second nodes corresponding to historical search and storage information of other clients stored in the server to obtain a matching result. The sending unit is configured to send the matching result to the client.

In order to solve the above technical solutions, an Internet recommendation device is further provided according to the present disclosure. The device includes a memory and a processor. The memory stores a computer program. The processor is configured to, when executing the computer program, perform the Internet recommendation method described above.

In order to solve the above technical solutions, a computer-readable storage medium is further provided according to the present disclosure. The computer-readable storage medium stores a computer program. The computer program, when executed by a processor, causes the processor to perform the Internet recommendation method described above.

In summary, an Internet recommendation method, an Internet recommendation system, an Internet recommendation device, and a computer-readable storage medium are provided according to the present disclosure. Current search information inputted by a client is obtained, and then a first node corresponding to the current search information is determined in the tree-structure information chain. The server further stores search information inputted by other clients and second nodes corresponding to the tree-structure information chain. The first node is matched with the second nodes according to a predetermined matching rule, and then a matching result is sent to the client. In this way, a sufficiently large scope of initial screening can be ensured and the scope of the secondary screening can be reduced, thereby facilitating the user finding a target social user.

### BRIEF DESCRIPTION OF THE DRAWINGS

In order to more clearly illustrate the technical solutions in the embodiments of the present disclosure, drawings to be used in the description of the embodiments or the conventional technology are briefly described hereinafter. It is apparent that the drawings in the following description show only some embodiments of the present disclosure. Those skilled in the art can obtain other drawings based on these drawings without any creative efforts.

FIG. 1 is a flowchart of an Internet recommendation method according to the present disclosure;

FIG. 2 is a schematic structural diagram of a tree-structure information chain in an Internet recommendation method according to the present disclosure; and

FIG. 3 is a schematic diagram of a bilateral structure in an Internet recommendation method according to the present disclosure.

### DETAILED DESCRIPTION OF EMBODIMENTS

An Internet recommendation method, an Internet recommendation system, an Internet recommendation device, and a computer-readable storage medium are provided according to the present disclosure, to ensure a sufficiently large scope of initial screening and reduce the scope of secondary screening in the user socializing through the Internet and facilitate the user finding a target social user.

In order to make the objectives, technical solutions and advantages of the embodiments of the present disclosure clear, technical solutions in the embodiments of the present disclosure are described below in conjunction with the drawings in the embodiments of the present disclosure. Apparently, the embodiments described below are only some embodiments of the present disclosure, rather than all the embodiments. Any other embodiments obtained by those skilled in the art based on the embodiments in the present disclosure without any creative effort fall within the protection scope of the present disclosure.

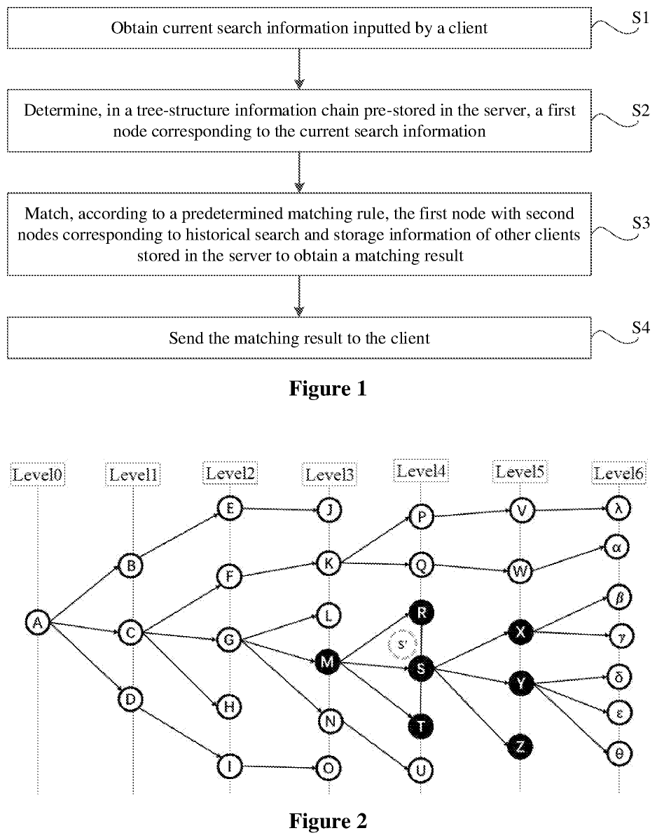

Reference is made to FIG. 1, which is a flowchart of an Internet recommendation method according to the present disclosure. The Internet recommendation method is applied to a server. The method includes the following steps S1 to S4.

In step S1, current search information inputted by a client is obtained.

In step S2, a first node, corresponding to the current search information and in a tree-structure information chain pre-stored in the server, is determined. The tree-structure information chain includes multiple nodes in a tree structure and node information corresponding to the nodes one by one.

In step S3, the first node is matched with second nodes corresponding to historical search and storage information of other clients stored in the server according to a predetermined matching rule to obtain a matching result.

In step S4, the matching result is sent to the client.

In the conventional technology, a large number of search results are obtained in searching for a target social user through search engines such as the Internet, and then it takes a lot of time to manually perform secondary screening on the initial search results. In the conventional technology, a target social user may be searched using social software such as WeChat. However, in this way, it is required to know a social account of the target social user first, and the scope of initial search is small.

In order to solve the above technical problems, an Internet recommendation method is provided according to the present disclosure. According to the Internet recommendation method, after the user inputs current search information through a client, the current search information is obtained at the server, and then a first node corresponding to the current search information is obtained based on a tree-structure information chain. The tree-structure information chain has a tree structure including multiple levels. Each of the levels includes one or more nodes, and each of the nodes corresponds to a piece of node information. After the first node is obtained, the first node is matched with second nodes stored in the server according to a predetermined matching rule, so that the scope of initial screening is reduced and the accuracy of the search can be ensured. Then, a matching result is sent to the client, so that the target social user is determined.

In addition, the historical search and storage information in the present disclosure includes search information previously inputted by other clients and storage information that is pre-stored in the server and inputted by other clients. Both the search information previously inputted by other clients and the storage information pre-stored in the server correspond to node information in the tree-structure information chain, so as to obtain a corresponding second node and a matching result.

It should further be noted that in a case that a node in the second nodes corresponding to the historical search and storage information is the same as the first node, the client corresponding to the node is preferentially matched to the client searching for a target social user. Reference is made to FIG. 2, which is a schematic structural diagram of a tree-structure information chain in an Internet recommendation method according to the present disclosure. FIG. 2 shows a case abstracted from the IPC classification table of the World Intellectual Property Organization. It is assumed that a first node corresponding to a client searching for a target social user is a node S shown in FIG. 2, and a node S′ and the node S are the same node, then a client corresponding to the node S′ is preferentially matched to the client corresponding to the first node.

Taking IPC patent classification number an example, the IPC patent classification number includes a vertical part, a major category, a minor category, a major group, a minor group, and a dotted group. When the user want to search for a target social user to obtain patent related information about expertise and professional requirements of the target social user, it is difficult for the user to accurately find the target social user with the conventional technology due to the numerous patent classifications. Based on the IPC patent classification number, patents may be classified by the vertical part, the major category, the minor category, the major group, the minor group, and the dotted group. In the present disclosure, a tree-structure information chain is configured in the server, and the tree-structure information chain includes six levels of nodes corresponding to the vertical part, the major category, the minor category, the major group, the minor group, and the dotted group. When the user wants to search for a target social user to learn about patent related information, the server corresponds current search information inputted by the user to a first node in the tree-structure information chain. Then, the first node is matched with the second nodes stored in the server according to a predetermined matching rule, and finally a matching result is fed back to the client. The tree-structure information chain may also be applicable to Nice goods and services classification tables, national economy classification tables, labor occupation classification tables, and the like.

In summary, an Internet recommendation method, an Internet recommendation system, an Internet recommendation device, and a computer-readable storage medium are provided according to the present disclosure. Current search information inputted by a client is obtained, and then a first node corresponding to the current search information is determined in the tree-structure information chain. The server further stores search information inputted by other clients and second nodes corresponding to the tree-structure information chain. The first node is matched with the second nodes according to a predetermined matching rule, and then a matching result is sent to the client. In this way, a sufficiently large scope of initial screening can be ensured and the scope of the secondary screening can be reduced, thereby facilitating the user finding a target social user.

Based on the above embodiments, in an embodiment, the first node may be matched with the second nodes corresponding to the historical search and storage information of other clients stored in the server according to the predetermined matching rule to obtain the matching result by: obtaining distances between the first node and the second nodes based on the tree-structure information chain; arranging the distances in a rule from near to far to obtain a first distance sequence; obtaining a second node sequence based on the first distance sequence and a correspondence relationship between the distances in the first distance sequence and the second nodes; and obtaining the matching result based on a correspondence relationship between the second node sequence and the historical search and storage information.

In the embodiment, the distances between the first node and the second nodes stored in the server are obtained based on the tree-structure information chain. In the tree-structure information chain, a smaller distance between the first node and a second node indicates a stronger correlation between the first node and the second node, and indicates that it is closer to the target social user that the user searches for. Therefore, the distances are arranged in a rule from near to far to obtain the first distance sequence. Then, the second node sequence is obtained based on the correspondence relationship between the distances in the first distance sequence and the second nodes, so that the first node is matched to the second nodes. Finally, the matching result is obtained based on the correspondence relationship between the second node sequence and the historical search and storage information. In this way, the scope of initial screening is reduced in the user searching for a target social user, thereby performing an accurate search.

It should be noted that the first distance sequence and the second node sequence in the present disclosure are intermediate data generated by the server in order to obtain the matching result. The first distance sequence and the second node sequence are not to be sent to the client, and only the matching result is sent to the client for display.

Referring to FIG. 2, FIG. 2 is a schematic structural diagram of a tree-structure information chain in an Internet recommendation method according to the present disclosure. Taking the node S in FIG. 2 as an example, a distance between a node M and the node S is less than a distance between a node G and the node S, so that a matching degree of the node M and the node S is higher than a matching degree of the node G and the node S.

As a preferred embodiment, in a case that multiple second nodes having a same distance from the first node, after the second node sequence is obtained based on the first distance sequence and the correspondence relationship between the distances in the first distance sequence and the second nodes, the method further includes: determining a relationship between each of the second nodes having the same distance from the first node and the first node based on the tree-structure information chain, where the relationship between each of the second nodes and the first node comprises that the second node is a child node of the first node, the second node is a peer node of the first node, and the second node is a parent node of the first node; and arranging the second nodes having the same distance from the first node in the second node sequence in an order of a second node being a child node of the first node, a second node being a peer node of the first node, and then a second node being a parent node of the first node.

In the embodiment, multiple second nodes may have a same distance from the first node in the server. Nodes in different levels in the tree-structure information chain are divided from coarse to fine, and child nodes have accurate information. Therefore, it is required to determine a relationship between each of the second nodes having the same distance from the first node and the first node, and then the second nodes having the same distance from the first node in the second node sequence are arranged in an order of a second node being a child node of the first node, a second node being a peer node of the first node, and then a second node being a parent node of the first node.

Referring to FIG. 2, FIG. 2 is a schematic structural diagram of a tree-structure information chain in an Internet recommendation method according to the present disclosure. In FIG. 2, each of a node M, a node R, a node T, a node X, a node Y and a node Z has a same distance with a node S. The node M is a parent node of the node S. The node R and the node T are peer nodes of the node S. The node X, the node Y and the node Z are child nodes of the node S. Therefore, the nodes are arranged in an order of: node X, node Y, node Z, node M, node R, and node T.

As a preferred embodiment, in a case that multiple identical distances exist in the first distance sequence, after the second node sequence is obtained based on the first distance sequence and the correspondence relationship between the distances in the first distance sequence and the second nodes, the method further includes: arranging, based on storage time instants of the second nodes, second nodes having a same distance from the first node in the second node sequence in an order of the storage time instants from late to early.

In the embodiment, there may be multiple second nodes having a same distance from the first node in the server. A launch time instant of other client corresponding to a second node having a later storage time instant is closer to a current searching time instant of the client, and the other client is more likely to successfully socialize with the client. Therefore, in the embodiment, it is further required to arrange, based on the storage time instants of the second nodes, the multiple second nodes having the same distance from the first node in the second node sequence in the order of the storage time instants from late to early.

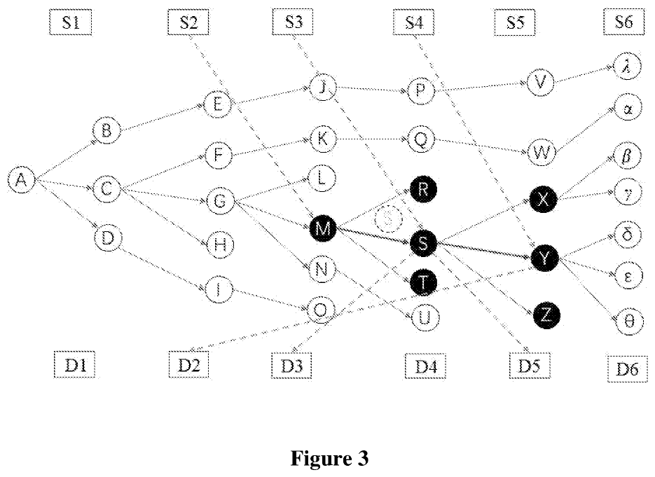

Taking FIG. 3 as an example, FIG. 3 is a schematic diagram of a bilateral structure in an Internet recommendation method according to the present disclosure. In FIGS. 3, S1, S2, S3, S4, S5 and S6 represent clients, D1, D2, D3, D4, D5 and D6 represent other clients, a storage time instant of D3 is later than a storage time instant of the client D5. Current search information of the client S2 matches a node M. Current search information of the client S3 matches a node S. Current search information of the client S4 matches a node Y. Historical search information of other client D2 matches the node Y. Historical search information of other client D3 matches the node S. Historical search information of other client D5 matches the node S. According to the order of a child node, a parent node, and then a peer node, and the order of the storage time instants from late to early, a matching result for the client S2 is D3, D5, and D2, a matching result for the client S3 is D3, D5 and D2, and a matching result for the client S4 is D2, D3, and D5.

As a preferred embodiment, the current search information inputted by the client is obtained by: obtaining the current search information selected by the client from a predetermined menu bar, where a structure of the predetermined menu bar is identical to a structure of the tree-structure information chain or is identical to a structure of a level of the tree-structure information chain.

In the embodiment, the client in performing search independently may input inaccurate search information due to lack of understanding of relevant field. Therefore, the client may be configured to select current search information from a predetermined menu bar. The structure of the predetermined menu bar is consistent with the structure of the tree-structure information chain or is consistent with a structure of a level of the tree-structure information chain, and the nodes in the tree-structure information chain may be ended at a current level or point to a child level, which are not limited in the present disclosure.

In a case that the structure of the predetermined menu bar is consistent with a structure of a lowest level of the tree-structure information chain, the scope of secondary screening may be effectively reduced, thereby reducing uncertainty of the user inputting information.

As a preferred embodiment, the current search information inputted by the client is obtained by: obtaining current custom search information inputted by the client. The first node, corresponding to the current search information, in the tree-structure information chain pre-stored in the server is determined by: determining, in the tree-structure information chain, the first node corresponding to the current search information selected by the client from the predetermined menu bar and/or the current custom search information.

In the embodiment, the user may select the current search information from the predetermined menu bar, and may input the custom search information in a search box. In addition, the process of obtaining the first node based on the current search information selected from the predetermined menu bar and the process of obtaining the first node based on the custom search information inputted in the search box may have an “and” relationship, thereby achieving an accurate matching result. Alternatively, the process of obtaining the first node based on the current search information selected from the predetermined menu bar and the process of obtaining the first node based on the custom search information inputted in the search box may have an “or” relationship, thereby achieving a wide matching scope.

In order to solve the above technical problems, an Internet recommendation system is further provided according to the present disclosure. The system includes a search information obtaining unit, a first node determination unit, a matching unit, and a sending unit. The search information obtaining unit is configured to obtain search information inputted by a client. The first node determination unit is configured to determine, in a tree-structure information chain pre-stored in a server, a first node corresponding to the search information. The matching unit is configured to match, according to a predetermined matching rule, the first node with second nodes corresponding to historical search and storage information of other clients stored in the server to obtain a matching result. The sending unit is configured to send the matching result to the client.

The descriptions of the Internet recommendation system according to the present disclosure may refer to the above embodiments of the Internet recommendation method, which are not repeated herein.

In order to solve the above technical problems, an Internet recommendation device is further provided according to the present disclosure. The device includes a memory and a processor. The memory stores a computer program. The processor is configured to, when executing the computer program, perform the Internet recommendation method described above.

The descriptions of the Internet recommendation device according to the present disclosure may refer to the above embodiments of the Internet recommendation method, which are not repeated herein.

In order to solve the above technical problems, a computer-readable storage medium is further provided according to the present disclosure. The computer-readable storage medium stores a computer program. The computer program, when executed by a processor, causes the processor to perform the Internet recommendation method described above.

The descriptions of the computer-readable storage medium according to the present disclosure may refer to the above embodiments of Internet recommendation method, which are not repeated herein.

The above embodiments in the specification are described in a progressive manner. Each of the embodiments is mainly focused on the differences from other embodiments, and reference may be made among these embodiments with respect to the same or similar parts. Since the device disclosed in the embodiment corresponds to the method disclosed in the embodiment, the description for the device is simple, and reference may be made to the method in the embodiment for the relevant parts.

The above description of the embodiments herein enables those skilled in the art to implement or use the present disclosure. Various modifications to the embodiments are apparent for the skilled in the art. The general principle defined herein may be implemented in other embodiments without departing from the spirit or scope of the present disclosure. Therefore, the present disclosure is not limited to the embodiments disclosed herein, but is to conform to the widest scope in accordance with the principles and novel features disclosed herein.

1. An Internet recommendation method, applied to a server, and comprising:
obtaining current search information inputted by a client;
determining, in a tree-structure information chain pre-stored in the server, a first node corresponding to the current search information, wherein the tree-structure information chain comprises a plurality of nodes in a tree structure and node information corresponding to the nodes one by one;
matching, according to a predetermined matching rule, the first node with second nodes corresponding to historical search and storage information of other clients stored in the server to obtain a matching result; and
sending the matching result to the client.

2. The Internet recommendation method according to claim 1, wherein the matching, according to a predetermined matching rule, the first node with second nodes corresponding to historical search and storage information of other clients stored in the server to obtain a matching result comprises:
obtaining distances between the first node and the second nodes based on the tree-structure information chain;
arranging the distances in a rule from near to far to obtain a first distance sequence;
obtaining a second node sequence based on the first distance sequence and a correspondence relationship between the distances in the first distance sequence and the second nodes; and
obtaining the matching result based on a correspondence relationship between the second node sequence and the historical search and storage information.

3. The Internet recommendation method according to claim 2, wherein in a case of a plurality of second nodes having a same distance from the first node, after obtaining the second node sequence based on the first distance sequence and the correspondence relationship between the distances in the first distance sequence and the second nodes, the Internet recommendation method further comprises:
determining a relationship between each of the second nodes having the same distance from the first node and the first node based on the tree-structure information chain, wherein the relationship between each of the second nodes and the first node comprises that the second node is a child node of the first node, the second node is a peer node of the first node, and the second node is a parent node of the first node; and
arranging the second nodes having the same distance from the first node in the second node sequence in an order of a second node being a child node of the first node, then a second node being a peer node of the first node, and then a second node being a parent node of the first node.

4. The Internet recommendation method according to claim 2, wherein in a case that a plurality of identical distances exist in the first distance sequence, after obtaining the second node sequence based on the first distance sequence and the correspondence relationship between the distances in the first distance sequence and the second nodes, the Internet recommendation method further comprises:
arranging, based on storage time instants of the second nodes, second nodes having a same distance from the first node in the second node sequence in an order of the storage time instants from late to early.

5. The Internet recommendation method according to claim 1, wherein the obtaining current search information inputted by a client comprises:
obtaining the current search information selected by the client from a predetermined menu bar, wherein a structure of the predetermined menu bar is identical to a structure of the tree-structure information chain or is identical to a structure of a level of the tree-structure information chain.

6. The Internet recommendation method according to claim 5, wherein
the obtaining current search information inputted by a client further comprises: obtaining current custom search information inputted by the client; and
the determining, in a tree-structure information chain pre-stored in the server, a first node corresponding to the current search information comprises: determining, in the tree-structure information chain, the first node corresponding to the current search information selected by the client from the predetermined menu bar and/or the current custom search information.

7. An Internet recommendation system, comprising:
a search information obtaining unit, configured to obtain search information inputted by a client;
a first node determination unit, configured to determine, in a tree-structure information chain pre-stored in a server, a first node corresponding to the search information;
a matching unit, configured to match, according to a predetermined matching rule, the first node with second nodes corresponding to historical search and storage information of other clients stored in the server to obtain a matching result; and
a sending unit, configured to send the matching result to the client.

8. An Internet recommendation device, comprising:
a memory, storing a computer program; and
a processor, configured to, when executing the computer program, perform the Internet recommendation method according to claim 1.

9. A computer-readable storage medium storing a computer program, wherein the computer program, when executed by a processor, causes the processor to perform the Internet recommendation method according to claim 1.
